(19) United States
(12) Patent Application Publication
(10) Pub. No.: US 2005/0060267 A1
(43) Pub. Date: Mar. 17, 2005

(54) Sales managing system of utilization right with respect to utilization object, sales server, terminal device and sales managing method

(76) Inventor: Yoshinobu Inada, Kobe-shi (JP)

Correspondence Address: OSHA & MAY L.L.P., 1221 MCKINNEY STREET, HOUSTON, TX, 77010, US

(21) Appl. No.: 10/909,754

(22) Filed: Jul. 30, 2004

(30) Foreign Application Priority Data
Aug. 1, 2003 (JP) 2003-285190
Oct. 20, 2003 (JP) 2003-359213
Jun. 24, 2004 (JP) 2004-186428

(51) Int. Cl. G06F 17/60

(52) U.S. Cl. 705/59; 705/10

(57) ABSTRACT

The invention can reduce a system load within a sales server, and provides a more rapid service by simplifying the construction and the function of the sales server. In a utilization license solving server of the sales server, when a utilization right certificate is solved on the basis of a utilization license about contents desired by a user and is transmitted to a user terminal device, the utilization right certificate is stored and managed in a utilization right certificate managing section. In a service solving server, when a utilization right is solved on the basis of this utilization right certificate and is transmitted to the user terminal device, the utilization right is stored and managed in a utilization right managing section. Thereafter, when the utilization right is presented by the user, the contents corresponding to this utilization right are transmitted from a contents managing server to the user terminal device.

### BACKGROUND OF THE INVENTION

1. Field of the Invention

The present invention relates to a sales managing system of a utilization right about a digitalized utilization object for selling the utilization right through a communication network, a sales server, a terminal device and a sales managing method.

2. Background Art

As an information providing service utilizing the communication network is spread, the utilization object such as a literary production, etc. including at least one of a text, an image (a static image and a dynamic image), a voice and a program as information is digitalized and often circulated. Accordingly, a necessary property for establishing an appropriate providing method is raised in a service based on new media or techniques such as the Internet.

Here, for example, a managing system of the digital literary production for selling a utilizable right about the digital literary production to a user is disclosed in patent JP-A-2002-215828 proposed by the applicant of the present application. In such a managing system, the user can receive delivery of the digital literary production corresponding to this right by exercising this right in the terminal device. Accordingly, the user can utilize the digital literary production corresponding to this right in a range conformed to this right.

However, in such a managing system, data showing the utilizable right about the digital literary production, etc. obtained (purchased) by the user are collectively managed every user (terminal device) in the managing server instead of the user. Accordingly, a memory device (hard disk, etc.) of large capacity for storing many right data is required in the managing server. Further, the construction, the function, etc. of the managing server become complicated, and a large burden is imposed on the managing server. As its result, when the user uses the digital literary production, etc., for example, time required to deliver the digital literary production, etc. is resultantly lengthened, which becomes a factor for giving a feeling of unnecessary stress to the user.

### SUMMARY OF THE INVENTION

Therefore, an object of the present invention is to provide a sales managing system of the utilization right about the utilization object, a sales server, a terminal device and a sales managing method able to reduce the system burden within the sales server and provide a more rapid service by simplifying the construction and the function of the sales server.

A sales managing system of a utilization right about a utilization object in the present invention comprises a sales server which includes a utilization right certificate issuing function for issuing a utilization right certificate including data showing a utilizable right range about the utilization object on the basis of information about the utilization object supplied from a terminal device, and able to transmit this utilization right certificate to the terminal device, and also includes a utilization right issuing function for issuing the utilization right including the same data as at least one portion of the utilization right certificate issued by the utilization right certificate issuing function and data for measuring a utilizing amount in the terminal device of the utilization object corresponding to this utilization right certificate, and able to transmit the utilization right to the terminal device; and the terminal device including a utilization right managing function able to receive, store and manage the utilization right certificate and the utilization right about the utilization object transmitted from the sales server.

A sales server of a utilization right about a utilization object in the present invention comprises a utilization right certificate issuing function for issuing a utilization right certificate including data showing a utilizable right range about the utilization object on the basis of information about the utilization object supplied from a terminal device, and able to transmit this utilization right certificate to the terminal device, and a utilization right issuing function for issuing the utilization right including the same data as at least one portion of the utilization right certificate issued by the utilization right certificate issuing function and data for measuring a utilizing amount in the terminal device of the utilization object corresponding to this utilization right certificate, and able to transmit the utilization right to the terminal device.

A terminal device of a utilization right about a utilization object in the present invention has a utilization right managing function able to receive, store and manage a utilization right certificate and the utilization right about the utilization object transmitted from a sales server.

A sales managing method of a utilization right about a utilization object in the present invention comprises a utilization right certificate issuing step for issuing a utilization right certificate including data showing a utilizable right range about the utilization object on the basis of information about the utilization object supplied from a terminal device in a sales server; a utilization right certificate transmitting step for transmitting the utilization right certificate issued by the utilization right certificate issuing step from the sales server to the terminal device; a utilization right certificate receiving step for receiving the utilization right certificate transmitted by the utilization right certificate transmitting step in the terminal device; a utilization right issuing step for issuing the utilization right including the same data as at least one portion of the utilization right certificate designated by the terminal device, and data for measuring a utilizing amount in the terminal device of the utilization object corresponding to this utilization right certificate in the sales server; a utilization right transmitting step for transmitting the utilization right issued by the utilization right issuing step from the sales server to the terminal device; a utilization right receiving step for receiving the utilization right transmitted by the utilization right transmitting step in the terminal device; and a utilization right managing step for storing and managing the utilization right certificate and the utilization right about the utilization object transmitted from the sales server in the terminal device.

In accordance with these constructions, since the utilization right certificate and the utilization right issued in the sales server are transmitted to the terminal device, the utilization right certificate and the utilization right are managed every user in the terminal device by storing the utilization right certificate and the utilization right within the terminal device. Accordingly, since it is not necessary to store and manage many utilization right certificates and utilization rights in the sales server, the load of the server can be reduced and the construction and the function of the sales server are simplified and a more rapid service can be provided.

Further, the utilization object, its utilization license, and a utilizing action based on this utilization license can be perfectly treated separately. Accordingly, for example, the utilization object is not communized but can be commonly used on the basis of the utilization license through the digital network between many unspecified users or many specified users as in a case in which an exhibition work and an exhibition object are appreciated in an art museum, a museum, etc. with the utilization object as the only original object. Namely, the utilization object can be appreciated together and used together It can be also said that this is a credit creating mechanism in one kind of knowledge field with intellectual assets as a security through the utilization right.

A sales managing system of a utilization right about a utilization object in the present invention comprises a sales server which includes a utilization right certificate issuing function for issuing a utilization right certificate including data showing a utilizable right range about the utilization object on the basis of information about the utilization object supplied from a terminal device, and also includes a utilization right issuing function for issuing the utilization right including the same data as at least one portion of the utilization right certificate issued by the utilization right certificate issuing function and data for measuring a utilizing amount in the terminal device of the utilization object corresponding to this utilization right certificate, and able to transmit the utilization right to the terminal device; and the terminal device including a utilization right managing function able to receive, store and manage the utilization right about the utilization object transmitted from the sales server.

A sales server of a utilization right about a utilization object in the present invention comprises a utilization right certificate issuing function for issuing a utilization right certificate including data showing a utilizable right range about the utilization object on the basis of information about the utilization object supplied from a terminal device, and a utilization right issuing function for issuing the utilization right including the same data as at least one portion of the utilization right certificate issued by the utilization right certificate issuing function and data for measuring a utilizing amount in the terminal device of the utilization object corresponding to this utilization right certificate, and able to transmit the utilization right to the terminal device.

A terminal device of a utilization right about a utilization object in the present invention has a utilization right managing function able to receive, store and manage the utilization right about the utilization object transmitted from a sales server.

A sales managing method of a utilization right about a utilization object in the present invention comprises a utilization right certificate issuing step for issuing a utilization right certificate including data showing a utilizable right range about the utilization object on the basis of information about the utilization object supplied from a terminal device in a sales server; a utilization right issuing step for issuing the utilization right including the same data as at least one portion of the utilization right certificate designated by the terminal device, and data for measuring a utilizing amount in the terminal device of the utilization object corresponding to this utilization right certificate in the sales server; a utilization right transmitting step for transmitting the utilization right issued by the utilization right issuing step from the sales server to the terminal device; a utilization right receiving step for receiving the utilization right transmitted by the utilization right transmitting step in the terminal device; and a utilization right managing step for storing and managing the utilization right about the utilization object transmitted from the sales server in the terminal device.

In accordance with these constructions, since the utilization right issued in the sales server is transmitted to the terminal device, the utilization right is managed every user in the terminal device by storing the utilization right into the terminal device. Accordingly, since it is not necessary to store and manage many utilization rights in the sales server, the construction and the function of the sales server are simplified and a more rapid service can be provided.

Further, the utilization object, its utilization license, and a utilizing action based on this utilization license can be perfectly treated separately. Accordingly, for example, the utilization object is not communized but can be commonly used on the basis of the utilization license through the digital network between many unspecified users or many specified users as in a case in which an exhibition work and an exhibition object are appreciated in an art museum, a museum, etc. with the utilization object as the only original object. Namely, the utilization object can be appreciated together and used together. It can be also said that this is a credit creating mechanism in one kind of knowledge field with intellectual assets as a security through the utilization right.

In the sales managing system of the utilization right about the utilization object in the present invention, the sales server may further have a utilization right certificate information managing function for storing information relating to the utilization right certificate about plural utilization objects, and able to retrieve the information relating to the utilization right certificate about the utilization object corresponding to information supplied from the terminal device.

In the sales server of the utilization right about the utilization object in the present invention, the sales server may further have a utilization right certificate information managing function for storing information relating to the utilization right certificate about plural utilization objects, and able to retrieve the information relating to the utilization right certificate about the utilization object corresponding to information supplied from the terminal device.

In accordance with these constructions, information relating to the utilization right certificate about plural utilization objects can be easily retrieved. Accordingly, the user can easily obtain the utilization right certificate about the utilization object desired in accordance with necessity from the utilization right certificates able to be sold in the sales server. As its result, a convenient property of the user in purchasing the utilization right certificate is improved.

In the sales managing system of the utilization right about the utilization object in the present invention, the sales server may further have a utilization object managing function for storing a utilizable utilization object in the terminal device, and able to transmit the utilization object corresponding to the utilization right designated in the terminal device.

In the sales server of the utilization right about the utilization object in the present invention, the sales server may further have a utilization object managing function for storing a utilizable utilization object in the terminal device, and able to transmit the utilization object corresponding to the utilization right designated in the terminal device.

In accordance with these constructions, when the utilization right is designated by the user by managing the utilization object within the sales server, the utilization object can be efficiently transmitted.

In the sales managing system of the utilization right about the utilization object in the present invention, the utilization right issued by the utilization right issuing function maybe transmitted to the terminal device independently of the utilization object corresponding to this utilization right.

In the sales server of the utilization right about the utilization object in the present invention, the utilization right issued by the utilization right issuing function may be transmitted to the terminal device independently of the utilization object corresponding to this utilization right.

In accordance with these constructions, at a time point at which the utilization right required in utilizing the utilization object is transmitted to the terminal device independently of the utilization object and the user requires the utilization object, the utilization object corresponding to this utilization right is transmitted to the terminal device. Accordingly, it is not necessary to secure the capacity of a memory device (hard disk, etc.) for storing the utilization rights and the utilization objects corresponding to all of these utilization rights in the terminal device. As its result, the capacity of the memory device (hard disk, etc.) on the side of the terminal device can be further reduced.

In the sales managing system of the utilization right about the utilization object in the present invention, the utilization right issued by the utilization right issuing function may be integrated with the utilization object corresponding to this utilization right and may be transmitted to the terminal device.

In the sales server of the utilization right about the utilization object in the present invention, the utilization right issued by the utilization right issuing function may be integrated with the utilization object corresponding to this utilization right and may be transmitted to the terminal device.

In accordance with these constructions, the utilization right required in utilizing the utilization object is integrated with the utilization object and is transmitted to the terminal device. Accordingly, when the user requires the utilization object, the utilization object can be immediately utilized in the terminal device by storing the utilization object integrated with the utilization right within the terminal device.

In the sales managing system of the utilization right about the utilization object in the present invention, the utilization right certificate may be vanished when the utilization right is issued on the basis of the utilization right certificate in the utilization right issuing function.

In the sales server of the utilization right about the utilization object in the present invention, the utilization right certificate may be vanished when the utilization right is issued on the basis of the utilization right certificate in the utilization right issuing function.

In accordance with these constructions, when the utilization right is issued on the basis of the utilization right certificate, this utilization right certificate becomes extinct. Accordingly, the utilization right certificate and the utilization right corresponding to this utilization right certificate do not coexist. Accordingly, the utilization right certificate or the utilization right with respect to a predetermined utilizable right range about the utilization object is easily managed.

In the sales managing system of the utilization right about the utilization object in the present invention, the utilization right certificate and the utilization right may include attribute data for management.

In the sales server of the utilization right about the utilization object in the present invention, the utilization right certificate and the utilization right may include attribute data for management.

In accordance with these constructions, processings such as storage and management of the utilization right certificate and the utilization right in the terminal device are automatized on the basis of these attribute data for management. Therefore, the burden of the user side relating to these processings can be reduced, and a common policy for management can be applied between the user terminal devices with respect to the management of the utilization right certificate and the utilization right.

In the sales managing system of the utilization right about the utilization object in the present invention, the terminal device may have the utilization right managing function able to receive, store and manage the utilization right certificate and the utilization right about the utilization object transmitted from the sales server, and the terminal device may be able to transfer, exchange and lend and borrow at least one of the utilization right certificate and the utilization right between this terminal device and another terminal device.

In the terminal device of the utilization right about the utilization object in the present invention, the terminal device may be able to transfer, exchange and lend and borrow at least one of the utilization right certificate and the utilization right between this terminal device and another terminal device.

In the sales managing system of the utilization right about the utilization object in the present invention, the terminal device may have the utilization right managing function able to receive, store and manage the utilization right about the utilization object transmitted from the sales server, and the terminal device may be able to transfer, exchange and lend and borrow the utilization right between this terminal device and another terminal device.

In the terminal device of the utilization right about the utilization object in the present invention, the terminal device may be able to transfer, exchange and lend and borrow the utilization right between this terminal device and another terminal device.

In accordance with these constructions, the utilization right certificate or the utilization right can be transferred, exchanged, lent and borrowed between the users by transmitting and receiving the utilization right certificate or the utilization right between the terminal devices. Accordingly, the number of utilizing modes about the utilization object is increased so that the convenient property of the user is improved. For example, since the utilization right certificate or the utilization right can be transferred, exchanged, lent and borrowed between the users, it is also possible to perform operations having effects similar to those of these actions as in wide distribution of the utilization right certificate or the utilization right, etc.

In the sales managing system of the utilization right about the utilization object in the present invention, the utilization right certificate and the utilization right may include attribute data for management, and the utilization right certificate and the utilization right may be managed by the utilization right managing function on the basis of the attribute data for management.

In the sales managing system of the utilization right about the utilization object in the present invention, the utilization right may include attribute data for management, and the utilization right may be managed by the utilization right managing function on the basis of the attribute data for management.

In the terminal device of the utilization right about the utilization object in the present invention, the utilization right certificate and the utilization right may include attribute data for management, and the utilization right certificate and the utilization right may be managed by the utilization right managing function on the basis of the attribute data for management.

In the terminal device of the utilization right about the utilization object in the present invention, the utilization right may include attribute data for management, and the utilization right may be managed by the utilization right managing function on the basis of the attribute data for management.

In the sales managing method of the utilization right about the utilization object in the present invention, the utilization right certificate and the utilization right may include attribute data for management, and the utilization right certificate and the utilization right may be managed on the basis of the attribute data for management in the utilization right managing step.

In the sales managing method of the utilization right about the utilization object in the present invention, the utilization right may include attribute data for management, and the utilization right may be managed on the basis of the attribute data for management in the utilization right managing step.

In accordance with these constructions, processings such as storage and management of the utilization right certificate and the utilization right in the terminal device are automatized on the basis of these attribute data for management. Therefore, the burden of the user side relating to these processings can be reduced, and a common policy for management can be applied between the user terminal devices with respect to the management of the utilization right certificate and the utilization right.

In the sales managing system of the utilization right about the utilization object in the present invention, the terminal device may further have a utilization object storing function able to receive and store the utilization object.

In the terminal device of the utilization right about the utilization object in the present invention, the terminal device may further have a utilization object storing function able to receive and store the utilization object.

In accordance with these constructions, for example, when the utilization object storing function has a function as a permanently storable memory device such as a hard disk, the utilization object corresponding to the utilization right is stored into the terminal device. Thus, when the utilization object is utilized within a utilizable range based on the utilization right, it is not necessary to newly receive the utilization object. Accordingly, the utilization object can be immediately utilized even when it is an offline state (=non-contact state in which no terminal device is connected to the sales server or the digital network) in the terminal device.

Further, for example, when the utilization object storing function has a function as a temporarily storable memory device such as a main memory of the terminal device, the corresponding utilization object is transmitted to the terminal device at a time point at which the utilization right is exercised in the terminal device irrespective of the difference between real time and non-real time in a utilizing environment of the utilization object. Thus, the corresponding utilization object can be utilized only while the utilization right is exercised, or only while a power source of the terminal device is turned on. Further, the utilization object can be set to be unutilized by breaking or vanishing the utilization object (data) from the terminal device, etc. at a time point at which the exercise of the utilization right is stopped or terminated, or at a time point at which the power source of the terminal device is turned off. Thus, for example, it is also possible to cope with the utilization of the utilization object in which the utilizing mode in an online state (=connecting state to the sales server or the digital network) is set to a premise as in application software requiring download from the network even time streaming contents and the utilization right are exercised.

Here, “an object (digital literary production) relating to the digital literary production” and “an object except for the object relating to the digital literary production” are included in the “utilization object”. One example of the utilization object is shown in the following description.

“The object relating to the digital literary production” includes a game (game software), music, video, newspaper, a novel, a magazine, teaching materials, a catalog, application software (application program), digital data in which teaching material software, software for learning, etc. in a school, network learning, etc. are digitalized. Streaming media (streaming contents) of Website broadcasting expected to become very general in the future, so-called Internet television broadcast (Web television), a radio, etc., i.e., news transmitted in media, etc. for simultaneously executing download and regeneration of digital data, contents of a sports relay broadcast, a network concert, network screening, a network relay broadcast, etc. are also set to the digital literary production.

Further, “the object except for the object relating to the digital literary production” includes digital data in which tickets of a concert, a drama, a movie, a sports event, etc., tickets of a passenger airplane, a railway, etc., lecture taking tickets of a training course, a lecture course, etc., various kinds of money tickets such as a goods ticket, a coupon ticket, etc., various kinds of tickets such as a commutation ticket, a pass, a coupon ticket, etc. are digitalized.

Further, for example, a network terminal (portable, desktop, laptop), etc. mounting a program for digital data regeneration of a game, music, video, a text, etc., a communication application program (Web browser, etc.) and a network OS (operation system), etc. are used as the terminal device. In addition to a case in which the utilization object of the digital literary production, etc. is directly delivered from the managing server to the terminal device, the utilization object of the digital literary production, etc. may be also delivered to the terminal device through another device.

Thus, in the present invention, even when the utilization object is contents and is also a certain service, its utilization object can be abstracted as the utilization license and the utilization right certificate. Therefore, various kinds of services can be efficiently provided through the network by absorbing the difference in provided service from the digital literary production delivery service of AV software, etc. to the issue of a ticket of a concert, etc., the issue of a certain utilization pass, the issue of a goods ticket, a coupon ticket, etc.

Further, it is possible to include a license portion dynamically determined on the basis of a need of the user side in the utilization license and the utilization right certificate. A utilization license portion entrusted to a selection or determination of the user side can be described in this dynamically determined license portion separately from a license portion able to be described on the basis of each own providing plan on the provider side of the utilization object. Accordingly, the utilization license and the utilization right certificate can be more efficiently provided in conformity with the need of the user side.

Further, in the present invention, the utilization license and the utilization right certificate are separated from each other for the following reasons. Namely, it is possible to flexibly cope with various kinds of needs of the user side on the service provider side by arbitrarily selecting or combining the utilization licenses in conformity with the need of the user side and being able to logically and dynamically construct the utilization license as the utilization right certificate. Further, the utilization license dynamically selected or combined in this way can be authenticated as a just utilization license by solving the utilization license as the utilization right certificate by a utilization license solving server. Thus, the utilization license can be more safely used. Further, the utilization license can be treated as independent data in the format of the utilization right certificate separately from the utilization object of the utilization license so that a moving property or a circulating property of the utilization license can be raised in the shape of e.g., a coupon ticket, a goods ticket, etc.

In the utilization of the utilization object such as contents, etc., the utilization object is treated by separating the utilization object into the utilization right certificate and the utilization right. This is because a flexible and efficient system having an excellent convenient property can be constructed and a service of this system can be provided by clearly separately treating the contents of the utilization license describing the right range of the utilization object with respect to the utilization of the utilization object, and a utilizing action of the utilization object based on the contents of this utilization license. Namely, the contents of the utilization license are abstracted as the utilization right certificate, and the utilizing action based on the contents of the utilization license of this utilization right certificate is abstracted as the utilization right, Thus, for example, even in the case of the utilization object inhibited in lending and borrowing and transfer of this utilization right, etc., the utilization right certificate directly unrelated to the utilizing action of the utilization object, or unusable to directly download the utilization object to the terminal device can be lent and borrowed, transferred, etc. Thus, the utilizing action of the utilization object inhibited in lending and borrowing, transfer of the utilization right, etc. can be resultantly lent and borrowed, transferred, etc. the utilizing action of such a utilization object can be also presented, etc. Further, with respect to payment account settlement relating to the utilization of the utilization object, one of a time point for solving the utilization license to the utilization right certificate and a time point for solving the utilization right certificate to the utilization right can be arbitrarily selected in conformity with a service providing mode. Further, since these two functions are separately treated, there is also an advantage in that an optimum security mechanism, its level, etc. can be flexibly selected in conformity with these functions and a utilizing environment.

Further, the attribute information for management is set in the utilization right certificate and the utilization right because the utilizing environment more intuitively and easily understood can be provided to a user. For example, one portion or all of processings of classification and management of the utilization right certificate and the utilization right downloaded to the terminal device of the user, and relating or logic grouping, etc. based on the mutual corresponding relation between the related utilization right certificates and utilization rights can be automatized in (application of) the sales server and the terminal device on the basis of its set attribute information for management. Further, when the utilization right certificate and the utilization right are exchanged, transferred, lent and borrowed, etc. between the terminal devices, a common management policy based on the attribute information for management can be applied between the terminal devices. Accordingly, one portion or all of these operations can be automatized.

Thus, as the management system is simplified, the utilization license describing the right range of the utilization with respect to the digital literary production and the utilizing action of the digital literary production based on the contents of this utilization license are separated from each other in the utilization of the digital literary production. The utilization license and the utilizing action are abstracted as the utilization right certificate and the utilization right. Thus, each of the utilization license and the utilizing action can be independently treated and circulated. Further, the attribute information for management using a machine and the application can be arbitrarily set in both the utilization right certificate and the utilization right. Thus, this managing system and the managing method can be set to be more flexible and excellent in the convenient property. Further, this managing system and the managing method can be also applied to provision and utilization through the digital network of various kinds of services able to become the utilization object as well as the digital literary production by extending the above digital literary production to an arbitrary utilization object able to set the utilization right.

### BRIEF DESCRIPTION OF THE DRAWINGS

FIG. 1 is a block diagram showing the construction of a sales managing system in accordance with an embodiment mode of the present invention.

FIG. 2 is a flow chart showing operating steps of the sales managing system in accordance with this embodiment mode.

### DESCRIPTION OF THE PREFERRED EMBODIMENTS

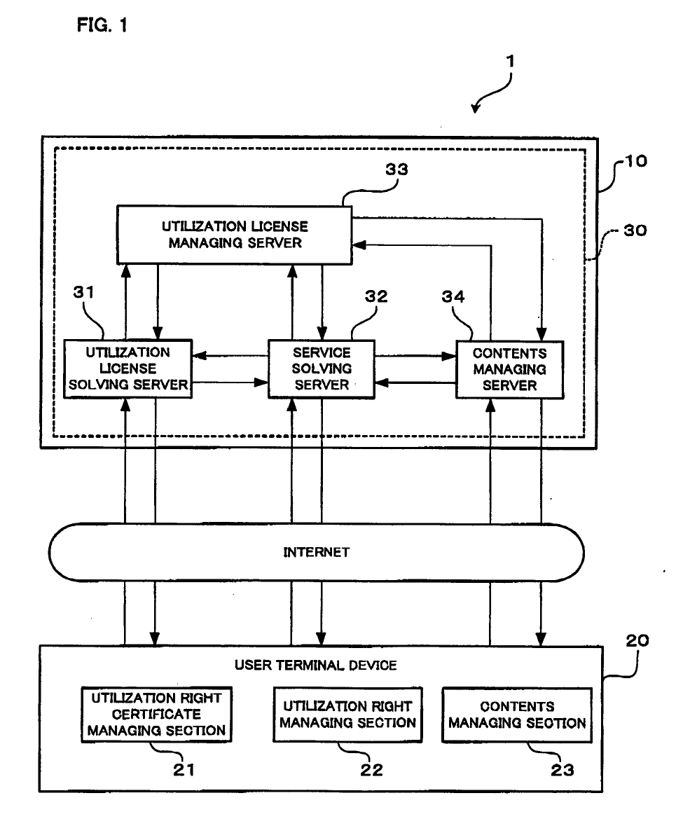

The construction of a sales managing system 1 of a utilization right about contents in accordance with one preferred embodiment mode of the present invention will next be explained with reference to the drawings. FIG. 1 is a block diagram showing the construction of the sales managing system in accordance with this embodiment mode.

<Entire Construction of Sales Managing System>

As shown in FIG. 1, the sales managing system 1 of a utilization right certificate and a utilization right about a document, etc. (hereinafter called “contents”) relating to a digital literary production and certain service provision includes a system (hereinafter called a “computer system”) 10 and a user terminal device 20 as a computer system on the utilizing side of the contents. The computer system 10 is constructed by a computer functioning as a sales server 30 having a main function of the sales managing system 1 and various kinds of peripheral devices. Here, the computer system 10 and the user terminal device 20 are connected to each other through the Internet, and can mutually transmit and receive data.

Each of the computer system 10 and the user terminal device 20 has various kinds of unillustrated hardware such as a CPU, a memory, a hard disk, a DVD, etc., and is a computer system which installs various software including a GUI base OS, a network OS, various kinds of network applications, and various kinds of applications for management and regeneration, etc. Each of the computer system 10 and the user terminal device 20 can be connected to a computer network such as the Internet, etc. through a communication device such as a router, a modem, etc.

The sales server 30 within the computer system 10 has a utilization license solving server 31, a service solving server 32, a utilization license managing server 33 and a contents managing server 34.

On the other hand, the user terminal device 20 has a utilization right certificate managing section 21, a utilization right managing section 22 and a contents managing section 23. The user terminal device 20 can be connected to the sales server 30 through the Internet, etc. A network application for receiving the provision of a utilization right certificate, a utilization right, contents data, etc. about the contents of the digital literary production, etc. from the sales server 30 is installed into the user terminal device 20.

Here, the detailed function of each portion of each server included in the sales server 30 and the user terminal device 20 will be explained.

<Utilization License Solving Server>

The utilization license solving server 31 has a retrieving inquiry function to the utilization license managing server 33 on the basis of a retrieving request of a utilization license from the user terminal device 20. The utilization license solving server 31 also has a retrieving result providing function to the user terminal device 20 on the basis of a retrieving result in the utilization license managing server 33. The utilization license solving server 31 also has a function for notifying a solved utilization right certificate to the utilization license managing server 33. The utilization license solving server 31 also has a utilization license solving function for issuing the utilization right certificate to the user terminal device 20 on the basis of the request from the user terminal device 20. The utilization license solving server 31 further has a function for transmitting the utilization right certificate to the user terminal device 20, a payment account settlement function provided by the utilization license solution, and an unfair altering and unfair use preventing function of the utilization right certificate.

Accordingly, when there is a request of information retrieval about the utilization license from the user terminal device 20, the utilization license solving server 31 inquires of the utilization license managing server 33 about the retrieval, and provides its retrieving result to the user terminal device 20. Further, when there is a solving (issue) request of the utilization right certificate about the utilization of contents from the user terminal device 20, the utilization license solving server 31 solves the utilization right certificate relating to this utilization of the contents, and transmits the utilization right certificate to the user terminal device 20. Further, the utilization license solving server 31 notifies information relating to this solved (issued) utilization right certificate to the utilization license managing server 33. Further, the utilization license solving server 31 can settle the account of payment with respect to the solution to the utilization right certificate based on the selection of a user between the utilization license solving server 31 and the user terminal device 20. Further, the utilization license solving server 31 can perform encryption processing of utilization right certificate data and can affix a digital signature to the utilization right certificate data, etc. Further, decoding processing of the ciphered data, confirmation of the digital signature, etc. can be also executed in the utilization license solving server 31.

Thus, a main role of the utilization license solving server 31 is to retrieve utilization license information desired by the user on the basis of a solving request of the utilization license from the user terminal device 20, and dynamically solve and issue the utilization right certificate related to contents as a utilization object but not directly related to their utilization on the basis of this retrieval.

<Service Solving Server>

The service solving server 32 has a solving request inquiry function to the utilization license managing server 33 based on a service solving request from the user terminal device 20. The service solving server 32 also has a solving function to the utilization right of the utilization right certificate based on an inquiry result to the utilization license managing server 33. The service solving server 32 also has an inquiry function of contents to the contents managing server 34 on the basis of the service solving request from the user terminal device 20. The service solving server 32 also has a solving function to the utilization right with contents of the utilization right certificate on the basis of an inquiry result to the contents managing server 34. The service solving server 32 also has a function for transmitting the utilization right, etc. to the user terminal device 20. The service solving server 32 further has a payment account settlement function provided by the service solution, and an unfair altering and unfair use preventing function of the utilization right and the utilization right with contents.

Accordingly, when there is a service solving request about the utilization right certificate from the user terminal device 20, the service solving server 32 inquires of the utilization license managing server 33 about a fair property of the utilization right certificate, etc. (hereinafter called “verification of the utilization right certificate”). After the service solving server 32 confirms that the utilization right certificate is a right utilization right certificate, the service solving server 32 solves the utilization right certificate presented by the user to the utilization of a utilization object related to this utilization right certificate and the utilization right used in control of the utilization. Further, when the user selects a solution to the utilization right with contents in the service solution of the utilization right certificate, the service solving server 32 inquires of the contents managing server 34 about information with respect to the contents corresponding to this utilization right, and solves the utilization right certificate to the utilization right with contents. The service solving server 32 also transmits the utilization right and the utilization right with contents to the user terminal device 20. Further, the service solving server 32 can settle the account of payment with respect to the solution to the utilization right or the utilization right with contents of the utilization right certificate based on the selection of the user between the service solving server 32 and the user terminal device 20. Further, the encryption processing of data of the utilization right and the contents can be performed and a digital signature, etc. can be affixed in their data. Further, the service solving server 32 can also execute decoding processing of the ciphered data, confirmation of the digital signature, etc.

Thus, a main role of the service solving server 32 is to solve the utilization right certificate desired by the user to the utilization right or the utilization right with contents corresponding to this utilization right certificate on the basis of the service solving request from the user terminal device 20.

In this embodiment mode, when the utilization right or the utilization right with contents is solved on the basis of the utilization right certificate in the service solving server 32, the original utilization right certificate can be also set so as to become extinct. Accordingly, when a problem is caused in coexistence of the utilization right certificate and the utilization right (utilization right with contents) in the user terminal device 20 (e.g., when there is a possibility of double use, etc.), it is possible to set the utilization right certificate and the utilization right such that the utilization right certificate and the utilization right do not coexist.

<Utilization License Managing Server>

The utilization license managing server 33 has a storing function of utilization license information from a utilization license provider. The utilization license managing server 33 also has a retrieval processing function based on a utilization license retrieving inquiry request from the utilization license solving server 31. The utilization license managing server 33 also has a function for providing a retrieving result of the utilization license information to the utilization license solving server 31. The utilization license managing server 33 also has a registration managing function of the utilization right certificate solved (issued) on the basis of notification from the utilization license solving server 31. The utilization license managing server 33 also has an inquiry processing function based on a verifying request of the utilization right certificate from the service solving server 32. The utilization license managing server 33 further has a function for providing a verifying result of the utilization right certificate to the service solving server 32, and an unfair altering and unfair use preventing function of the utilization license information.

Accordingly, the utilization license managing server 33 manages information about the utilization license provided to the sales server 30. Further, when there is a retrieving request from the utilization license solving server 31, the utilization license managing server 33 performs retrieval processing and then provides the retrieving result to the utilization license solving server 31. Further, the utilization license managing server 33 registers the utilization right certificate solved (issued) on the basis of the notification from the utilization license solving server 31, and manages its record. When there is an inquiry relating to the verification of the utilization right certificate from the service solving server 32, the utilization license managing server 33 provides the verifying result corresponding to this inquiry. Further, the utilization license managing server 33 can perform encryption processing and can affix a digital signature, etc. with respect to the utilization license information. Further, the utilization license managing server 33 can also execute decoding processing of the ciphered data, confirmation of the digital signature, etc.

Thus, a main role of the utilization license managing server 33 is to store the utilization license information (copyright relating information, security relating information, attribute information for management relating to the utilization right certificate and the utilization right, price information, accounting or account settlement information, various kinds of metadata for retrieval of contents, etc.) provided from a utilization license provider to the sales server 30, and execute the retrieval processing and the verification processing and provide various kinds of information as a retrieving result and a verifying result to the utilization license solving server 31 or the service solving server 32.

<Contents Managing Server>

The contents managing server 34 has a storing function of contents, a contents inquiry processing function based on a contents inquiry request from the service solving server 32 or the user terminal device 20, a function for providing a contents inquiry result to the service solving server 32 or the user terminal device 20, and an unfair altering and unfair use preventing function of the contents.

Accordingly, the contents managing server 34 stores the contents provided to the sales server 30. Further, when there is an inquiry about the contents from the service solving server 32 or the user terminal device 20, the contents managing server 34 provides information corresponding to this inquiry and the contents. Further, the contents managing server 34 can perform encryption processing with respect to the contents and can affix a digital signature, etc. Further, the contents managing server 34 can also execute decoding processing of the ciphered data, confirmation of the digital signature, etc.

Thus, a main role of the contents managing server 34 is to store the contents provided from a contents provider to the sales server 30, and suitably provide the contents to the service solving server 31 or the user terminal device 20. Accordingly, for example, when the utilization right is designated from the user terminal device 20, the utilization right is presented to the contents managing server 34. If there is no problem after the contents managing server 34 verifies appropriateness of this utilization right, the contents managing server 34 retrieves the corresponding contents and transmits these contents to the user terminal device 20. At this time, there is a merit able to disperse the burden of the service solving server 32 to the contents managing server 34. However, in the case of the utilization right with contents, the contents are transmitted to the user terminal device 20 together with the utilization right through the service solving server 32.

The contents provider can set whether the contents are transferred, exchanged, etc. or not when the contents are provided to the contents managing server 34.

<User Terminal Device>

In the user terminal device 20, the utilization right certificate managing section 21 receives the utilization right certificate transmitted from the sales server 30 and then stores and manages the utilization right certificate. The utilization right managing section 22 receives the utilization right and the utilization right with contents transmitted from the sales server 30, and then stores and manages the utilization right and the utilization right with contents. Further, when the utilization of the contents is designated or required on the basis of the utilization right, and when the utilization right with contents is required, the contents managing section 23 receives the contents transmitted from the contents managing server 34 or the service solving server 32 and then stores and manages these contents. With respect to the utilization right with contents, the utilization right and the contents are separated from each other and are separately managed in the utilization right managing section 22 and the contents managing section 23.

Here, for example, the contents managing section 23 may have a function as a permanently storable recorder such as a hard disk, and may also have a function as a temporarily storable recorder such as a main memory of the user terminal device 20. Further, the contents managing section 23 may further have both the above functions (the function as the permanently storable recorder and the function as the temporarily storable recorder). Further, the contents managing section 23 may also have a detachable recorder such as a compact flash memory, etc.

For example, when the contents managing section 23 has the function as the permanently storable recorder such as a hard disk, the contents can be stored and managed in the contents managing section 23. Accordingly, when the contents are utilized within a utilizable range based on the utilization right by storing the contents corresponding to the utilization right, it is not necessary to newly re-receive the contents. Accordingly, for example, the contents can be immediately utilized even when it is an offline state (=state in which no user terminal device 20 is connected to the sales server 30 or the digital network) in the user terminal device 20.

Further, for example, when the contents managing section 23 has the function as the temporarily storable recorder such as a main memory of the user terminal device 20, the corresponding contents are transmitted to the user terminal device 20 at a time point at which the utilization right is exercised in the user terminal device 20 irrespective of the difference between real time and non-real time in a utilizing environment of the contents. Thus, the corresponding contents can be utilized only while the utilization right is exercised, or only while a power source of the user terminal device 20 is turned on. Further, the contents can be set so as to be unutilized by breaking or vanishing the contents (data) from the user terminal device 20, etc. at a time point at which the exercise of the utilization right is stopped or terminated, or at a time point at which the power source of the user terminal device 20 is turned off. Therefore, for example, it is also possible to cope with the utilization of the contents in which a utilizing mode in an online state (=connecting state to the sales server 30 or the digital network) is set to a premise as in application software requiring download from the network every time streaming contents and the utilization right are exercised.

The user terminal device 20 has a solving (which is issue, purchase or obtaining, etc. and is similarly defined hereinafter) request function to the retrieval of the utilization license to the utilization license solving server 31 and the utilization right certificate of the utilization license. The user terminal device 20 also has a receiving and storing function of the utilization right certificate from the utilization license solving server 31, and a transfer function, an exchanging function and a lending-borrowing function of the utilization right certificate between the user terminal devices. The user terminal device 20 also has a solving request function to the utilization right of the utilization right certificate with respect to the service solving server 32. The user terminal device 20 also has a receiving and storing function of the utilization right from the service solving server 32, and a function for relating the utilization right and the contents as its utilization object. The user terminal device 20 also has a payment account settlement function provided by solutions in the utilization license solving server 31 and the service solving server 32. The user terminal device 20 also has a utilization (which is regeneration, execution, presentation or exercise, etc. and is similarly defined hereinafter) function of the utilization right. The user terminal device 20 also has a utilizing control function (inhibition of the utilization exceeding a utilization limit, etc.) based on the utilization right. The user terminal device 20 further has a transfer function, an exchanging function and a lending-borrowing function of the utilization right between the user terminal devices, and an unfair altering and unfair use preventing function of the utilization right certificate and the utilization right.

Accordingly, the user terminal device 20 makes a retrieving request of the utilization license with respect to the utilization license solving server 31, and also makes a solving request to the utilization right certificate based on the contents of a selected or designated utilization license, and a solving request to the utilization right of the utilization right certificate. Further, the user terminal device 20 receives and stores the utilization right certificate, the utilization right and the contents, and can utilize the contents and can control the utilization through an operation and processing with respect to the utilization right. Further, when the account settlement of payment is generated by the solution to the utilization right certificate and the utilization right, the user terminal device 20 can settle the account of this payment between the user terminal device 20 and the sales server 30, and can perform encryption processing and can affix a digital signature, etc. with respect to the utilization right certificate and the utilization right. Further, the user terminal device 20 can also execute decoding processing of the ciphered data, confirmation of the digital signature, etc. The utilization right certificate and the utilization right can be transmitted and received between plural user terminal devices.

<Constructions of Utilization Right Certificate and Utilization Right>

The utilization right certificate includes information relating to the digital literary production, a utilizable right range about a certain service, a copyright, attribute data for management, security, etc. The utilization right certificate is given and taken in a format such as a certain electronic document, a binary format, etc. Its contents are dynamically determined on the basis of the utilization license and the need of a user. Here, the utilization license is provided from a contents provider with respect to the contents managing server 34 of the sales server 30 to the sales server 30 by a person (there is also a case in which this person is the same as the contents provider) purchasing or obtaining a license about these contents. The utilization license is a general term of license information used in the solution to the utilization right certificate. Further, the utilization license provider can set whether the utilization right certificate with respect to specific contents solved on the basis of the utilization license is transferred, exchanged, lent and borrowed, etc. or not.

The construction of the utilization right certificate will be explained in more detail. The utilization right certificate has a utilization right relative describing section, a copyright relative describing section, an attribute data relative describing section for management and a security relative describing section. Here, the contents of the utilization right relative describing section are mainly constructed by utilization license information provided by the contents provider, and a license portion and a license relating portion dynamically determined by a selection or designation made by the user. Further, the contents of the copyright relative describing section, the attribute data relative describing section for management and the security relative describing section are mainly constructed by a license portion and a license relating portion statically determined by the contents provider on the basis of a plan of the provider side.

For example, one set of utilization relating information such as a utilizing mode, a utilizing period and a utilizing time number of contents or their packages, etc., a price, a payment account settlement system or an accounting system, etc. is described in the utilization right relative describing section. Further, information as to whether the utilization right certificate is transferred, exchanged, lent and borrowed, etc. in a mode such as one kind of an electronic document, a binary format, etc. can be also described dynamically or statically in the utilization right relative describing section on the basis of the plan of the provider side and the need of the user side. Information relating to the utilization license can be referred by each allocated identifier, and can be also developed to contents referred by this identifier at a solving time point to the utilization right certificate of the utilization license, or a solving time point to the utilization right of the utilization right certificate.

For example, information relating to the digital literary production (contents) or its package, etc. (and also including an identifier relating to these, etc.) and copyright relating information of the digital literary production (contents), its package, etc. (also including an identifier able to univocally discriminate its copyright relating information, etc.) are described in the copyright relative describing section. Here, the copyright relating information is information as to whether the contents themselves are copied and printed or not, and are transferred, exchanged, lent and borrowed, etc. or not. These information can be referred by the identifier allocated to each information, and can be also developed to contents referred by this identifier at a solving time point to the utilization right certificate of the utilization license, or a solving time point to the utilization right of the utilization right certificate.

Various kinds of attribute data for management, etc. for being able to process logic group formation or logic relation of the utilization right certificate and the utilization right, their directory construction for management, lending and borrowing, transfer, exchange, etc. between the user terminal devices 20 of the utilization right certificate and the utilization right by (application of) the user terminal device 20 and the sales server 30 are set in the attribute data relative describing section for management when the utilization right certificate and the utilization right corresponding to contents, a service, etc. as a provided utilization object are stored to the terminal device of a user and are managed. These attribute data for management can be referred by the identifier allocated to each data, and can be also developed to contents referred by this identifier at a solving time point to the utilization right certificate of the utilization license, or a solving time point to the utilization right of the utilization right certificate.

For example, information relating to various kinds of protections (protection relating to a perfect property of contents, security of privacy, etc.), unfair copy prevention, etc. (and also including an identifier able to univocally discriminate information relating to a cipher system and security, etc.) is described in the security relative describing section. The information relating to security can be also referred by the identifier allocated to each information, and can be also developed to contents referred by this identifier at a solving time point to the utilization right certificate of the utilization license, or a solving time point to the utilization right of the utilization right certificate. When the utilization right certificate and the utilization right are transferred, exchanged, etc. between the user terminal devices by the function of the security relative describing section, and the contents are received and stored in the user terminal device, it is possible to restrain the generation of altering, damage, theft, etc. of these contents.

The utilization right is given and taken in a format such as a certain electronic document, a binary format, etc. assembling the contents of the original utilization right certificate thereto, and is directly related to the utilization of the contents corresponding to this utilization right. The contents are utilized and controlled only through an operation and processing with respect to this utilization right. On the other hand, when the utilization right is used as a ticket, a pass, etc. for utilizing a certain service, it is perfectly arbitrary to use this utilization right as an electronic ticket and an electronic pass themselves, or use this utilization right as data for input to an issuing or ticket selling system of the ticket, the pass, etc. Further, it is also perfectly arbitrary to use the utilization right in access control to a certain network service. Further, the utilization right is dynamically initialized on the basis of the contents of the utilization right certificate, and a function able to record a utilizing amount measured by the user terminal device 20 is also provided when the utilization of the contents is designated or required in the user terminal device 20.

Further, the utilization right certificate and the utilization right themselves can be referred by the identifier. Thus, the utilization right certificate and the utilization right having the same contents can be collectively managed by the side of the sales server 30. Thus, the managing burden of the sales server 30 is increased, but many utilization right certificates and utilization rights having the same contents are collectively managed in one portion. Accordingly, it is possible to efficiently perform the management of the utilization right certificate and the utilization right having the same contents as a whole and including exchange, lending and borrowing, transfer, etc. between these user terminal devices 20.

In this embodiment mode, no contents can be directly utilized on the basis of the utilization right certificate, but the utilization right certificate is solved to the utilization right in a service solution and the contents can be utilized and this utilization can be controlled only through an operation and processing with respect to this utilization right.

The utilization right certificate and the utilization right stored and managed in the utilization right certificate managing section 21 and the utilization right managing section 22 of the user terminal device 20 can be transmitted and received between the user terminal devices. Thus, the utilization right certificate and the utilization right can be lent and borrowed, exchanged, transferred, etc. between users. Here, when the utilization right is lent and borrowed, exchanged, etc. by the user terminal device 20, the contents corresponding to the utilization right are not necessarily simultaneously transmitted and received together with the utilization right between the user terminal devices. Accordingly, processing such as lending and borrowing and exchange of the utilization right, etc. can be rapidly performed, and the transmission and reception of the contents can be limited to only a required case. Therefore, unfair circulation of the contents can be correspondingly restrained.

Thus, for example, in the case of the utilization right certificate, it is possible to use the utilization right certificate as in a coupon ticket, a goods ticket, etc., and present the utilization right certificate to an arbitrary partner. Further, the utilization right certificate can be also used as in a formal utilization written application able to be mutually ordered around between users. On the other hand, in the case of the utilization right, it is possible to realize a utilizing method for obtaining effects similar to those of private lending and borrowing of music and video software, etc. conventionally generally performed.

<Operation of Managing System>

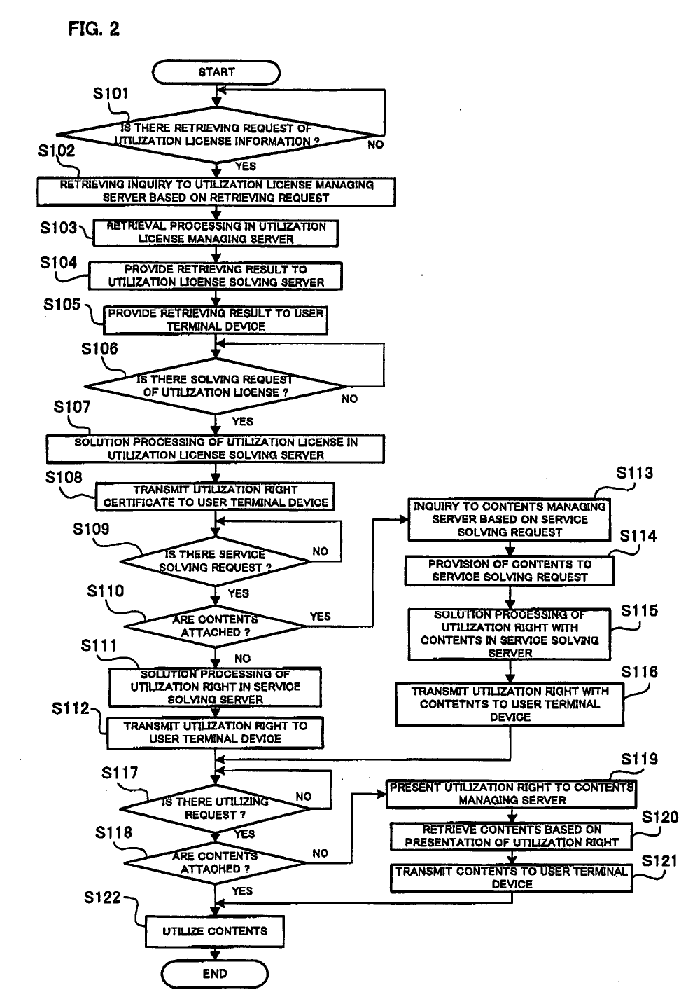

The operation from the sale of the utilization license in the sales managing system 1 in accordance with this embodiment mode to the utilization of the contents in the user terminal device 20 will next be explained with reference to FIG. 2. FIG. 2 is a flow chart showing operating steps of the sales managing system in accordance with this embodiment mode.

First, in the utilization license solving server 31, it is repeatedly judged whether there is a retrieving request of information relating to the utilization license from the user terminal device 20 or not (step S101). When there is a retrieving request (S101: YES), it proceeds to a step S102. A retrieving inquiry based on the retrieving request is then made from the utilization license solving server 31 to the utilization license managing server 33 (step S102). Thus, retrieval processing is executed in the utilization license managing server 33 (step S103), and its retrieving result is provided from the utilization license managing server 33 to the utilization license solving server 31 (step S104). Subsequently, its retrieving result is provided from the utilization license solving server 31 to the user terminal device 20 (step S105).

In the utilization license solving server 31, it is then repeatedly judged whether there is a solving request of the utilization license from the user terminal device 20 or not (step S106). When there is a solving request of the utilization license (S106: YES), it proceeds to a step S107. Thus, solution processing is executed in the utilization license solving server 31 (step S107). This solved utilization right certificate is transmitted from the utilization license solving server 31 to the user terminal device 20 (step S108).

Subsequently, in the service solving server 32, it is repeatedly judged whether or not there is a service solving request of the utilization right certificate from the user terminal device 20, i.e., a solving request of the utilization right (step S109). When there is a solving request of the utilization right (S109: YES), it is further judged whether the solving request is a solving request of the utilization right with contents or not (step S110). When the solving request is not the solving request of the utilization right with contents (S110: NO), it proceeds to a step S111.

Thus, the solution processing of the utilization right is executed in the service solving server 32 (step S111). This solved utilization right is transmitted from the service solving server 32 to the user terminal device 20 (step S112).

In contrast to this, when the solving request is a solving request of the utilization right with contents in the step 110, it proceeds to a step S113. Thus, an inquiry about the contents corresponding to the utilization right certificate as a source of the service solving request is made from the service solving server 32 to the contents managing server 34 (step S113). The contents corresponding to the utilization right certificate solved in service are then provided from the contents managing server 34 to the service solving server 32 (step S114). Thus, the solution processing of the utilization right with contents is executed in the service solving server 32 (step S115). This solved utilization right with contents is then transmitted from the service solving server 32 to the user terminal device 20 (step S116).

Thereafter, in the user terminal device 20, it is repeatedly judged whether there is a utilizing request of the utilization right or the utilization right with contents from a user or not (step S117). When there is a utilizing request (S117: YES), it is further judged whether the utilizing request is a utilizing request of the utilization right with contents or not (step S118). When no utilizing request is a utilizing request of the utilization right with contents (step S118: NO), it proceeds to a step S119.

The utilization right requested in utilization is then presented from the user terminal device 20 to the contents managing server 34 (step S119). Thus, contents based on the presentation of the utilization right are retrieved in the contents managing server 34 (step S120). The contents as a utilization object are then transmitted from the contents managing server 34 to the user terminal device 20 (step S121). Thus, the contents corresponding to the utilization right transmitted to the user terminal device 20 are utilized in the user terminal device 20 (step S122).

In contrast to this, when the utilizing request is a utilizing request of the utilization right with contents in the step S118 (step S118: YES), the contents corresponding to the utilization right with contents stored to the user terminal device 20 are utilized (step S122).

As explained above, in accordance with this embodiment mode, the utilization right certificate issued in the utilization license solving server 31 of the sales server 30 and the utilization right issued in the service solving server 32 are transmitted to the user terminal device 20. The utilization right certificate and the utilization right are then managed every user in the user terminal device 20 by storing the utilization right certificate and the utilization right into the user terminal device 20. Accordingly, since it is not necessary to store and manage many utilization right certificates and utilization rights in the sales server 30, the capacity of a memory device within the sales server 30 can be correspondingly reduced and the construction and the function of the sales server can be simplified. Further, processings such as the storage and the management in the terminal device of the utilization right certificate and the utilization right are automatized on the basis of their attribute data for management. Therefore, the burden of the user side relating to these processings can be reduced. Further, with respect to the management of the utilization right certificate and the utilization right, it is possible to apply a common policy for management between the user terminal devices 20.

Further, information relating to the utilization license about plural contents is managed in the utilization license managing server 33 of the sales server 30, and a retrieving result can be provided in accordance with a retrieving inquiry from the utilization license solving server 31. Accordingly, the user can easily retrieve the information relating to the utilization license about the plural contents. Accordingly, the user easily obtains the utilization license about desirable contents in accordance with necessity from the utilization licenses able to be sold in the sales server 30. As its result, the convenient property in purchasing the utilization license of the user is improved.

Further, in the contents managing server 34 of the sales server 30, the contents able to be utilized in the user terminal device 20 are managed, and the contents corresponding to the utilization right designated in the user terminal device 20 can be transmitted to the user terminal device 20 or the service solving server 32. Accordingly, the contents can be efficiently transmitted when the service solution of the utilization right certificate is performed or the utilization right is designated by the user.

Further, when the utilization right is solved on the basis of the utilization right certificate in the service solving server 32, the utilization right required in the utilization of the contents is transmitted to the user terminal device 20 independently (separately) of the contents, and the contents corresponding to this utilization right are transmitted to the user terminal device 20 at a time point at which the user requires the contents. Accordingly, when only the utilization right is solved on the basis of the utilization right certificate in the service solving server 32, it is not necessary to secure the capacity of a memory device required to store and manage all the contents corresponding to this utilization right within the user terminal device 20 in addition to the memory device capacity for storing and managing the utilization right. As its result, the memory device capacity within the user terminal device 20 can be correspondingly reduced.

Further, when the utilization right with contents is solved on the basis of the utilization right certificate in the service solving server 32, the utilization right required in the utilization of the contents is transmitted to the user terminal device 20 simultaneously with the contents. Accordingly, when the user requires the contents, the contents can be immediately utilized in the user terminal device 20 by storing and managing the simultaneously received utilization right and contents within the user terminal device 20.

Further, when the utilization right or the utilization right with contents is solved on the basis of the utilization right certificate in the service solving server 32, this utilization right certificate can be also set so as to become extinct. Accordingly, when there is a problem in the coexistence of the utilization right certificate and the utilization right corresponding to this utilization right certificate, the utilization right certificate and the utilization right can be set so as not to coexist. Accordingly, in this case, an unfair use such as a double use, etc. can be prevented in the management of the utilization right certificate or the utilization right (utilization right with contents) prescribing a utilizable predetermined right range about the contents.

Further, since the user terminal device 20 can store and manage the utilization right certificate in the utilization right certificate managing section 21, the user can perform the solution to the utilization right on the basis of the utilization right certificate and can utilize the contents by designating this utilization right at a time point at which the contents are required. Further, the processings such as the storage and the management in the terminal device of the utilization right certificate are automatized on the basis of its attribute data for management. Therefore, the burden of the user side relating to these processings can be reduced and a common policy for management can be applied between the user terminal devices 20 with respect to the management of the utilization right certificate.

Further, since the user terminal device 20 can store and manage the utilization right in the utilization right managing section 22, the user can utilize the contents by designating the utilization right at the time point at which the contents are required. Further, the processings such as the storage and the management in the terminal device of the utilization right are automatized on the basis of its attribute data for management. Therefore, the burden of the user side relating to these processings can be reduced and a common policy for management can be applied between the user terminal devices 20 with respect to the management of the utilization right.

Further, for example, when the contents managing section 23 of the user terminal device 20 has a function as a permanently storable recorder such as a hard disk, the contents can be stored and managed in the contents managing section 23. Accordingly, when the contents are utilized within a utilizable range based on the utilization right by storing the contents corresponding to the utilization right, it is not necessary to newly re-receive the contents. Accordingly, the contents can be immediately utilized even when it is an offline state (=state in which no user terminal device 20 is connected to the sales server 30 or the digital network) in the user terminal device 20.

Further, for example, when the contents managing section 23 of the user terminal device 20 has a function as a temporarily storable recorder such as a main memory of the user terminal device 20, the corresponding contents are transmitted to the user terminal device 20 at a time point at which the utilization right is exercised in the user terminal device 20. The corresponding contents can be utilized only while the utilization right is exercised, or only while a power source of the user terminal device 20 is turned on. Utilization disability can be set by breaking or vanishing the contents (data) from the user terminal device 20, etc. at a time point at which the exercise of the utilization right is stopped or terminated, or at a time point at which the power source of the user terminal device 20 is turned off.

The preferred embodiment modes of the present invention have been explained as mentioned above, but the present invention is not limited to the above embodiment modes. The present invention can be variously modified in design within the describing scope of the claims. For example, in the explanation of the above embodiment modes, the sales server 30 includes the utilization license managing server 33 and the contents managing server 34 in addition to the utilization license solving server 31 and the service solving server 32. However, it is sufficient to include at least the utilization license solving server 31 and the service solving server 32 in the sales server 30. An external function (a function except for the sales server 30) can be substituted for each of the utilization license managing server 33 and the contents managing server 34.

Further, in the explanation of the above embodiment modes, the sales server 30 is constructed in one computer system 10, but the present invention is not limited to this case. Each server can be also dispersed in plural computer systems dispersed in the digital network.

Further, the above embodiment modes are explained by considering that the utilization object is mainly a digital literary production. However, the present invention is not limited to this case. The utilization object may be also an object except for that relating to the digital literary production. Here, when the utilization object is the digital literary production, data relating to the digital literary production are transmitted from the contents managing server 34 to the user terminal device 20. However, when the utilization object is an object except for that relating to the digital literary production, how to treat and process the utilization right depends on an individual system providing various kinds of services cooperated with this sales server 30.

For example, in a certain service providing system, the utilization right itself might be used and treated as an electronic ticket and an electronic pass for utilizing a certain service. In another service providing system, the utilization right might be treated so as to newly issue proper ticket, pass, etc. by presenting the utilization right. As mentioned above, how to treat and process the utilization right can be arbitrarily selected in the individual service providing system. Therefore, even when it is the existing service providing system, the existing system can be effectively practically used as it is by merely interposing a data exchanging function as in a gateway between this system and the sales server 30 in the use of this system without newly reconstructing a system.

Further, in the explanation of the above embodiment modes, when the utilization license is solved to the utilization right certificate in the utilization license solving server 32, the utilization right certificate is transmitted to the user terminal device 20. Thereafter, when there is a service solving request of a user, the utilization right is solved on the basis of the utilization right certificate in the service solving server 32, and this utilization right is transmitted to the user terminal device 20. However, when the utilization license is solved to the utilization right certificate in the utilization license solving server 31, its utilization right certificate is not transmitted to the user terminal device 20, but may be subsequently presented to the service solving server 32 and may be solved to the utilization right or the utilization right with contents. This utilization right or the utilization right with contents maybe also transmitted to the user terminal device 20.

Further, in the above embodiment modes, when the utilization right or the utilization right with contents is solved on the basis of the utilization right certificate in the service solving server 32, this utilization right certificate can be set so as to become extinct. However, in a case similar to this case, no utilization right certificate may be also necessarily vanished. For example, when the utilization right certificate is practically used as one of sales promoting means, it is preferable to set the utilization right certificate so as not to become extinct such that this utilization right certificate is spread to many users as much as possible. However, for example, when an available period is set in the utilization right certificate, this utilization right certificate becomes extinct when the available period has passed irrespective of the solution to the utilization right or the utilization right with contents based on this utilization right certificate.

1. A sales managing system of a utilization right about a utilization object comprising:
a sales server which includes a utilization right certificate issuing function for issuing a utilization right certificate including data showing a utilizable right range about the utilization object on the basis of information about the utilization object supplied from a terminal device, and able to transmit this utilization right certificate to the terminal device, and also includes a utilization right issuing function for issuing the utilization right including the same data as at least one portion of the utilization right certificate issued by said utilization right certificate issuing function and data for measuring a utilizing amount in the terminal device of the utilization object corresponding to this utilization right certificate, and able to transmit the utilization right to the terminal device; and
the terminal device including a utilization right managing function able to receive, store and manage the utilization right certificate and the utilization right about the utilization object transmitted from said sales server.

2. A sales managing system of a utilization right about a utilization object comprising:
a sales server which includes a utilization right certificate issuing function for issuing a utilization right certificate including data showing a utilizable right range about the utilization object on the basis of information about the utilization object supplied from a terminal device, and also includes a utilization right issuing function for issuing the utilization right including the same data as at least one portion of the utilization right certificate issued by said utilization right certificate issuing function and data for measuring a utilizing amount in the terminal device of the utilization object corresponding to this utilization right certificate, and able to transmit the utilization right to the terminal device; and
the terminal device including a utilization right managing function able to receive, store and manage the utilization right about the utilization object transmitted from said sales server.

3. The sales managing system of the utilization right about the utilization object according to claim 1, wherein said sales server further has a utilization right certificate information managing function for storing information relating to the utilization right certificate about plural utilization objects, and able to retrieve the information relating to the utilization right certificate about the utilization object corresponding to information supplied from the terminal device.

4. The sales managing system of the utilization right about the utilization object according to claim 2, wherein said sales server further has a utilization right certificate information managing function for storing information relating to the utilization right certificate about plural utilization objects, and able to retrieve the information relating to the utilization right certificate about the utilization object corresponding to information supplied from the terminal device.

5. The sales managing system of the utilization right about the utilization object according to claim 1, wherein said sales server further has a utilization object managing function for storing a utilizable utilization object in the terminal device, and able to transmit the utilization object corresponding to the utilization right designated in the terminal device.

6. The sales managing system of the utilization right about the utilization object according to claim 2, wherein said sales server further has a utilization object managing function for storing a utilizable utilization object in the terminal device, and able to transmit the utilization object corresponding to the utilization right designated in the terminal device.

7. The sales managing system of the utilization right about the utilization object according to claim 1, wherein the utilization right issued by said utilization right issuing function is transmitted to the terminal device independently of the utilization object corresponding to this utilization right.

8. The sales managing system of the utilization right about the utilization object according to claim 2, wherein the utilization right issued by said utilization right issuing function is transmitted to the terminal device independently of the utilization object corresponding to this utilization right.

9. The sales managing system of the utilization right about the utilization object according to claim 1, wherein the utilization right issued by said utilization right issuing function is integrated with the utilization object corresponding to this utilization right and is transmitted to the terminal device.

10. The sales managing system of the utilization right about the utilization object according to claim 2, wherein the utilization right issued by said utilization right issuing function is integrated with the utilization object corresponding to this utilization right and is transmitted to the terminal device.

11. The sales managing system of the utilization right about the utilization object according to claim 1, wherein the utilization right certificate is vanished when the utilization right is issued on the basis of the utilization right certificate in said utilization right issuing function.

12. The sales managing system of the utilization right about the utilization object according to claim 2, wherein the utilization right certificate is vanished when the utilization right is issued on the basis of the utilization right certificate in said utilization right issuing function.

13. The sales managing system of the utilization right about the utilization object according to claim 1, wherein the utilization right certificate and the utilization right include attribute data for management.

14. The sales managing system of the utilization right about the utilization object according to claim 2, wherein the utilization right certificate and the utilization right include attribute data for management.

15. The sales managing system of the utilization right about the utilization object according to claim 1, wherein said terminal device has the utilization right managing function able to receive, store and manage the utilization right certificate and the utilization right about the utilization object transmitted from said sales server, and said terminal device can transfer, exchange and lend and borrow at least one of the utilization right certificate and the utilization right between this terminal device and another terminal device.

16. The sales managing system of the utilization right about the utilization object according to claim 15, wherein the utilization right certificate and the utilization right include attribute data for management, and
the utilization right certificate and the utilization right are managed by said utilization right managing function on the basis of the attribute data for management.

17. The sales managing system of the utilization right about the utilization object according to claim 2, wherein said terminal device has the utilization right managing function able to receive, store and manage the utilization right about the utilization object transmitted from said sales server, and
said terminal device can transfer, exchange and lend and borrow the utilization right between this terminal device and another terminal device.

18. The sales managing system of the utilization right about the utilization object according to claim 17, wherein the utilization right includes attribute data for management, and
the utilization right is managed by said utilization right managing function on the basis of the attribute data for management.

19. The sales managing system of the utilization right about the utilization object according to claim 1, wherein said terminal device further has a utilization object storing function able to receive and store the utilization object.

20. The sales managing system of the utilization right about the utilization object according to claim 2, wherein said terminal device further has a utilization object storing function able to receive and store the utilization object.

21. A sales server of a utilization right about a utilization object comprising:
a utilization right certificate issuing function for issuing a utilization right certificate including data showing a utilizable right range about the utilization object on the basis of information about the utilization object supplied from a terminal device, and able to transmit this utilization right certificate to the terminal device, and
a utilization right issuing function for issuing the utilization right including the same data as at least one portion of the utilization right certificate issued by said utilization right certificate issuing function and data for measuring a utilizing amount in the terminal device of the utilization object corresponding to this utilization right certificate, and able to transmit the utilization right to the terminal device.

22. A sales server of a utilization right about a utilization object comprising:
a utilization right certificate issuing function for issuing a utilization right certificate including data showing a utilizable right range about the utilization object on the basis of information about the utilization object supplied from a terminal device, and
a utilization right issuing function for issuing the utilization right including the same data as at least one portion of the utilization right certificate issued by said utilization right certificate issuing function and data for measuring a utilizing amount in the terminal device of the utilization object corresponding to this utilization right certificate, and able to transmit the utilization right to the terminal device.

23. The sales server of the utilization right about the utilization object according to claim 21, wherein said sales server further has a utilization right certificate information managing function for storing information relating to the utilization right certificate about plural utilization objects, and able to retrieve the information relating to the utilization right certificate about the utilization object corresponding to information supplied from the terminal device.

24. The sales server of the utilization right about the utilization object according to claim 22, wherein said sales server further has a utilization right certificate information managing function for storing information relating to the utilization right certificate about plural utilization objects, and able to retrieve the information relating to the utilization right certificate about the utilization object corresponding to information supplied from the terminal device.

25. The sales server of the utilization right about the utilization object according to claim 21, wherein said sales server, further has a utilization object managing function for storing a utilizable utilization object in the terminal device, and able to transmit the utilization object corresponding to the utilization right designated in the terminal device.

26. The sales server of the utilization right about the utilization object according to claim 22, wherein said sales server further has a utilization object managing function for storing a utilizable utilization object in the terminal device, and able to transmit the utilization object corresponding to the utilization right designated in the terminal device.

27. The sales server of the utilization right about the utilization object according to claim 21, wherein the utilization right issued by said utilization right issuing function is transmitted to the terminal device independently of the utilization object corresponding to this utilization right.

28. The sales server of the utilization right about the utilization object according to claim 22, wherein the utilization right issued by said utilization right issuing function is transmitted to the terminal device independently of the utilization object corresponding to this utilization right.

29. The sales server of the utilization right about the utilization object according to claim 21, wherein the utilization right issued by said utilization right issuing function is integrated with the utilization object corresponding to this utilization right and is transmitted to the terminal device.

30. The sales server of the utilization right about the utilization object according to claim 22, wherein the utilization right issued by said utilization right issuing function is integrated with the utilization object corresponding to this utilization right and is transmitted to the terminal device.

31. The sales server of the utilization right about the utilization object according to claim 21, wherein the utilization right certificate is vanished when the utilization right is issued on the basis of the utilization right certificate in said utilization right issuing function.

32. The sales server of the utilization right about the utilization object according to claim 22, wherein the utilization right certificate is vanished when the utilization right is issued on the basis of the utilization right certificate in said utilization right issuing function.

33. The sales server of the utilization right about the utilization object according to claim 21, wherein the utilization right certificate and the utilization right include attribute data for management.

34. The sales server of the utilization right about the utilization object according to claim 22, wherein the utilization right certificate and the utilization right include attribute data for management.

35. A terminal device of a utilization right about a utilization object characterized in that the terminal device has a utilization right managing function able to receive, store and manage a utilization right certificate and the utilization right about the utilization object transmitted from a sales server.

36. The terminal device of the utilization right about the utilization object according to claim 35, wherein the utilization right certificate and the utilization right include attribute data for management, and
the utilization right certificate and the utilization right are managed by said utilization right managing function on the basis of the attribute data for management.

37. The terminal device of the utilization right about the utilization object according to claim 35, wherein said terminal device can transfer, exchange and lend and borrow at least one of the utilization right certificate and the utilization right between this terminal device and another terminal device.

38. A terminal device of a utilization right about a utilization object characterized in that the terminal device has a utilization right managing function able to receive, store and manage the utilization right about the utilization object transmitted from a sales server.

39. The terminal device of the utilization right about the utilization object according to claim 38, wherein the utilization right includes attribute data for management, and
the utilization right is managed by said utilization right managing function on the basis of the attribute data for management.

40. The terminal device of the utilization right about the utilization object according to claim 38, wherein said terminal device can transfer, exchange and lend and borrow the utilization right between this terminal device and another terminal device.

41. The terminal device of the utilization right about the utilization object according to claim 35, wherein said terminal device further has a utilization object storing function able to receive and store the utilization object.

42. The terminal device of the utilization right about the utilization object according to claim 38, wherein said terminal device further has a utilization object storing function able to receive and store the utilization object.

43. A sales managing method of a utilization right about a utilization object comprising:
a utilization right certificate issuing step for issuing a utilization right certificate including data showing a utilizable right range about the utilization object on the basis of information about the utilization object supplied from a terminal device in a sales server;
a utilization right certificate transmitting step for transmitting the utilization right certificate issued by said utilization right certificate issuing step from the sales server to the terminal device;
a utilization right certificate receiving step for receiving the utilization right certificate transmitted by said utilization right certificate transmitting step in the terminal device;
a utilization right issuing step for issuing the utilization right including the same data as at least one portion of the utilization right certificate designated by the terminal device, and data for measuring a utilizing amount in the terminal device of the utilization object corresponding to this utilization right certificate in the sales server;
a utilization right transmitting step for transmitting the utilization right issued by said utilization right issuing step from the sales server to the terminal device;
a utilization right receiving step for receiving the utilization right transmitted by said utilization right transmitting step in the terminal device; and
a utilization right managing step for storing and managing the utilization right certificate and the utilization right about the utilization object transmitted from the sales server in the terminal device.

44. The sales managing method of the utilization right about the utilization object according to claim 43, wherein the utilization right certificate and the utilization right include attribute data for management, and
the utilization right certificate and the utilization right are managed on the basis of the attribute data for management in said utilization right managing step.

45. A sales managing method of a utilization right about a utilization object comprising:
a utilization right certificate issuing step for issuing a utilization right certificate including data showing a utilizable right range about the utilization object on the basis of information about the utilization object supplied from a terminal device in a sales server;
a utilization right issuing step for issuing the utilization right including the same data as at least one portion of the utilization right certificate designated by the terminal device, and data for measuring a utilizing amount in the terminal device of the utilization object corresponding to this utilization right certificate in the sales server;
a utilization right transmitting step for transmitting the utilization right issued by said utilization right issuing step from the sales server to the terminal device:
a utilization right receiving step for receiving the utilization right transmitted by said utilization right transmitting step in the terminal device; and
a utilization right managing step for storing and managing the utilization right about the utilization object transmitted from the sales server in the terminal device.

46. The sales managing method of the utilization right about the utilization object according to claim 45, wherein the utilization right includes attribute data for management, and
the utilization right is managed on the basis of the attribute data for management in said utilization right managing step.
